(19) United States
(12) Patent Application Publication
(10) Pub. No.: US 2020/0408955 A1
(43) Pub. Date: Dec. 31, 2020

(54) ANTIREFLECTION FILM AND OPTICAL MEMBER

(71) Applicant: FUJIFILM CORPORATION, Tokyo (JP)

(72) Inventors: Seigo NAKAMURA, Kanagawa (JP); Yoshiki MAEHARA, Kanagawa (JP); Tatsuya YOSHIHIRO, Kanagawa (JP); Kenichi UMEDA, Kanagawa (JP); Yuichiro ITAI, Kanagawa (JP); Fusao YAMANAKA, Kanagawa (JP)

(21) Appl. No.: 17/016,325

(22) Filed: Sep. 9, 2020

Related U.S. Application Data
(63) Continuation of application No. PCT/JP2018/047105, filed on Dec. 20, 2018.

(30) Foreign Application Priority Data
Mar. 29, 2018 (JP) 2018-063900

(51) Int. Cl. G02B 1/115

(52) U.S. Cl. CPC G02B 1/115

(57) ABSTRACT

The antireflection film includes a dielectric multilayer film arranged on the substrate side and a fine uneven layer containing an alumina hydrate as a main component and provided to be laminated on the dielectric multilayer film. The dielectric multilayer film includes alternating layers of layers of high refractive index having a relatively high refractive index and layers of low refractive index having a relatively low refractive index, the dielectric multilayer film includes a barrier layer containing silicon nitride as one of the layer of high refractive index and the layer of low refractive index, and the barrier layer has a density of 2.7 g/cm³ or more and a thickness of 15 nm or more and 150 nm or less.

### CROSS-REFERENCE TO RELATED APPLICATIONS

This application is a continuation application of International Application No. PCT/JP2018/047105, filed Dec. 20, 2018, the disclosure of which is incorporated herein by reference in its entirety. Further, this application claims priority from Japanese Patent Application No. 2018-063900, filed Mar. 29, 2018, the disclosure of which is incorporated herein by reference in its entirety.

### BACKGROUND OF THE INVENTION

### 1. Field of the Invention

The present disclosure relates to an antireflection film and an optical member including an antireflection film.

### 2. Description of the Related Art

Conventionally, in an optical member such as a lens, an antireflection function is provided to a light incident surface in order to reduce loss of transmitted light, ghost, and flare due to surface reflection.

As an antireflection film that provides an antireflection function for visible light, a configuration including a fine uneven layer having a pitch shorter than the wavelength of visible light is known (for example, WO2016/031133A (hereinafter, referred to as Patent Document 1)). In addition, as an antireflection film having no fine uneven structure, a dielectric multilayer film in which a layer of low refractive index and a layer of high refractive index are alternately laminated is known (for example, JP2009-084143A, (hereinafter, referred to as Patent Document 2)).

Patent Document 1 discloses an antireflection film in which an intermediate layer (dielectric layer) formed by alternately laminating a layer of low refractive index and a layer of high refractive index, and a fine uneven layer having an alumina hydrate as a main component are provided in this order on a substrate.

Patent Document 2 discloses an antireflection film consisting of a dielectric multilayer film, and a method of suppressing a change in optical properties in a heat treatment of a transparent substrate provided with an antireflection film at a glass softening temperature or a temperature close to the glass softening point. Specifically, it is proposed to provide a shielding layer that shields the diffusion of alkali ions between a layer that is easily deteriorated by contact with alkali ions such as sodium ions contained in a glass substrate, and the glass substrate.

### SUMMARY OF THE INVENTION

As a result of intensive studies of the present inventors, it has been found that the performance of an antireflection film comprising a fine uneven layer having an alumina hydrate as a main component as in Patent Document 1 is deteriorated with time in an environment at a temperature not exceeding 100° C. in some cases. Patent Document 2 describes that in the antireflection film consisting of a dielectric multilayer film, the diffusion of sodium ions becomes a problem in a case where the film is subjected to a heat treatment at a high temperature (for example, 550° C.) close to the softening temperature of the glass substrate. However, the antireflection film described in Patent Document 2 does not have a configuration including a fine uneven layer, and there is no discussion about deterioration in durability of the antireflection film in an environment at a temperature not exceeding 100° C.

The present disclosure has been made in view of the above circumstances. An object to be achieved by one embodiment of the present invention is to provide an antireflection film having excellent environmental durability and an optical member.

The present inventors have examined deterioration in the optical properties of an antireflection film comprising a fine uneven layer having an alumina hydrate as a main component in an environment at a temperature not exceeding 100° C. As a result, it has been found that in an environment of low humidity, deterioration does not occur even at a temperature of 85° C., while deterioration occurs at a temperature of 85° C. and a humidity of 85%. In the deteriorated antireflection film, precipitation of sodium carbonate (Na₂CO₃) was observed in the alumina hydrate. It is presumed that the precipitation of Na₂CO₃ causes a change in the refractive index of the fine uneven layer and a change in the reflectivity. It is considered that Na contained in the glass substrate passes through the dielectric layer, is diffused into the alumina hydrate, and reacts with carbon dioxide in the air to precipitate Na₂CO₃. In addition, the presence of Na ions and water produces sodium hydroxide (NaOH). Since aluminum is an amphoteric metal, its hydrate is soluble in NaOH. It is presumed that this NaOH causes dissolution to change the structure of the alumina hydrate, resulting in a change in the refractive index distribution and ultimately a change (increase) in the reflectivity. The present disclosure has been made based on the above findings.

An antireflection film according to the present disclosure is an antireflection film provided on one surface of a substrate, the film comprising:

a dielectric multilayer film arranged on the substrate side; and

a fine uneven layer having an alumina hydrate as a main component and provided to be laminated on the dielectric multilayer film,

in which the dielectric multilayer film includes alternating layers of layers of high refractive index having a relatively high refractive index and layers of low refractive index having a relatively low refractive index,

the dielectric multilayer film includes a barrier layer containing silicon nitride as one of the layer of high refractive index and the layer of low refractive index, and

the barrier layer has a density of 2.7 g/cm³ or more and a thickness of 15 nm or more and 150 nm or less.

Here, expressions “having a relatively high refractive index” and “having a relatively low refractive index” refer to a relative relationship between the layer of high refractive index and the layer of low refractive index, and mean that the layer of high refractive index has a higher refractive index than the layer of low refractive index, and the layer of low refractive index has a lower refractive index than the layer of high refractive index.

In the antireflection film according to the present disclosure, it is preferable that the barrier layer has a density of 3.1 g/cm³ or less.

In the antireflection film according to the present disclosure, it is preferable that the barrier layer has a thickness of 20 nm or more.

In the antireflection film according to the present disclosure, it is preferable that the barrier layer has a thickness of 100 nm or less.

In the antireflection film according to the present disclosure, the barrier layer may be provided adjacent to the substrate. Alternatively, one of the layers of low refractive index may be arranged adjacent to the substrate, and the barrier layer may be provided adjacent to the layer of low refractive index arranged adjacent to the substrate.

In the antireflection film according to the present disclosure, the barrier layer may be provided adjacent to the fine uneven layer. Alternatively, one of the layers of low refractive index may be arranged adjacent to the fine uneven layer, and the barrier layer may be provided adjacent to the layer of low refractive index arranged adjacent to the fine uneven layer.

In the antireflection film according to the present disclosure, the dielectric multilayer film may include two or more of the barrier layers.

In the antireflection film according to the present disclosure, the barrier layer may be provided as one of the layers of high refractive index, and

the layer of low refractive index may consist of silicon oxynitride.

An optical member according to the present disclosure comprises a substrate; and the antireflection film according to the present invention provided on one surface of the substrate.

In the optical member according to the present disclosure, a refractive index of the substrate at a wavelength of 500 nm may be 1.6 or more.

Since the antireflection film according to the present invention comprises the dielectric multilayer film arranged on the substrate side and the fine uneven layer having an alumina hydrate as a main component and provided to be laminated on the dielectric multilayer film, it is possible to realize a very low reflectivity, that is, high antireflection performance. Since the dielectric multilayer film includes a barrier layer consisting of silicon nitride as one of the layer of high refractive index and the layer of low refractive index, and the barrier layer has a density of 2.7 g/cm³ or more and a thickness of 15 nm or more and 150 nm or less, excellent environmental durability is realized in the antireflection film according to the present disclosure.

That is, since the antireflection film according to the present disclosure comprises such a barrier layer, for example, in a case where the antireflection film is provided on a substrate containing alkali metal ions such as sodium ions, it is possible to suppress the diffusion of alkali metal ions to the fine uneven layer side. Accordingly, it is possible to suppress a change in the refractive index of the fine uneven layer and a change in the refractive index and a change in the structure with time.

### BRIEF DESCRIPTION OF THE DRAWINGS

FIG. 1 is a schematic cross-sectional view showing an antireflection film and an optical member according to an embodiment of the present invention.

FIG. 2 is a schematic cross-sectional view for explaining an antireflection film of design modification example 1.

FIG. 3 is a schematic cross-sectional view for explaining an antireflection film of design modification example 2.

FIG. 4 is a schematic cross-sectional view for explaining an antireflection film of design modification example 3.

FIG. 5 is a schematic cross-sectional view for explaining an antireflection film of design modification example 4.

FIG. 6 is a schematic cross-sectional view for explaining an antireflection film of design modification example 5.

### DESCRIPTION OF THE PREFERRED EMBODIMENTS

Hereinafter, an embodiment of the present invention will be described with reference to the drawings.

In this specification, a numerical range expressed by using “to” means a range including numerical values described before and after “to” as a lower limit value and an upper limit value. In the numerical ranges described stepwise in the present disclosure, the upper limit value or the lower limit value described in a certain numerical range may be replaced with the upper limit value or the lower limit value of another numerical range described in a stepwise manner. In addition, in the numerical ranges described in the present disclosure, the upper limit value or the lower limit value described in a certain numerical range may be replaced with the values shown in the embodiment.

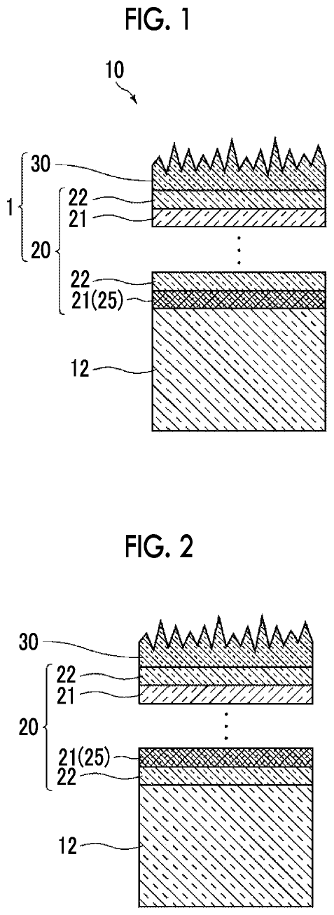

FIG. 1 is a schematic cross-sectional view showing a schematic configuration of an optical member 10 comprising an antireflection film 1 according to an embodiment of the present invention. As shown in FIG. 1, the optical member 10 according to the embodiment of the present embodiment comprises a substrate 12 and an antireflection film 1 formed on one surface of the substrate 12.

The antireflection film 1 comprises a dielectric multilayer film 20 arranged on the substrate side and a fine uneven layer 30 having an alumina hydrate as a main component and provided to be laminated on the dielectric multilayer film 20.

The dielectric multilayer film 20 consists of alternating layers of layers of high refractive index 21 having a relatively high refractive index and layers of low refractive index 22 having a relatively low refractive index.

The dielectric multilayer film 20 preferably includes two or more layers of high refractive index 21 and two layer or mores of low refractive index 22. As long as the layer of high refractive index 21 and the layer of low refractive index 22 are alternately laminated, the layer of low refractive index or the layer of high refractive index may be provided on a side closest to the substrate 12. In order to obtain preferable antireflection performance in a wider range, it is preferable that the dielectric multilayer film 20 is constituted of five or more layers. From the viewpoint of the film formation cost and the film formation time, the dielectric multilayer film 20 preferably has 20 layers or less.

The refractive indexes of the layer of high refractive index 21 and the layer of low refractive index 22 are relatively determined and thus are not particularly limited. The refractive index of the layer of high refractive index 21 is preferably about 1.6 to 2.4, and the refractive index of the layer of low refractive index 22 is preferably about 1.3 to 1.8. The refractive index of the layer of high refractive index 21 is more preferably 1.8 or more, and the refractive index of the layer of low refractive index 22 is more preferably less than 1.7. A difference in refractive index between the layer of high refractive index and the layer of low refractive index adjacent to each other is preferably 0.4 or more, and more preferably 0.6 or more. Unless otherwise specified, the refractive index is a value measured by ellipsometry at a wavelength of 500 nm.

The layers of high refractive index 21 do not have to be formed of the same material and do not have to have the same refractive index. However, it is preferable that the layers of high refractive index are formed of the same material and have the same refractive index from the viewpoint of suppressing the material cost and the film formation cost. Similarly, the layers of low refractive index 22 do not have to be formed of the same material and do not have to have the same refractive index. However, it is preferable that the layers of low refractive index are formed of the same material and have the same refractive index from the viewpoint of suppressing the material cost and the film formation cost.

The materials constituting the layer of high refractive index 21 and the layer of low refractive index 22 are not particularly limited as long as the materials satisfy the condition of the refractive index. These materials are not limited to the stoichiometric composition (stoichiometry) as long as the materials are transparent to the wavelength of light of which reflection is to be prevented, and materials having non-stoichiometric compositions (non-stoichiometry) can also be used. In order to adjust optical properties such as refractive index, and mechanical properties and improve productivity, the introduction of impurities is allowed. Here, the term “transparent” means that the internal transmittance is 10% or more with respect to the wavelength of light (antireflection target light) of which reflection is to be prevented in the optical member.

Examples of the materials of the layer of low refractive index 22 include silicon oxide, silicon oxynitride, gallium oxide, aluminum oxide, lanthanum oxide, lanthanum fluoride, magnesium fluoride, and a mixture thereof. Silicon oxynitride is particularly preferable.

Examples of the materials of the layer of high refractive index 21 include niobium oxide, niobium silicon oxide, zirconium oxide, tantalum oxide, silicon nitride, titanium oxide, hafnium oxide, lanthanum titanate, and a mixture thereof.

For forming each layer of the dielectric multilayer film 20, it is preferable to use a physical vapor deposition method such as vacuum vapor deposition (particularly EB vapor deposition), and sputtering, and various chemical vapor deposition methods (CVD). According to the vapor deposition methods, it is possible to easily form the lamination structure having various refractive indexes and layer thicknesses.

The dielectric multilayer film 20 includes a barrier layer 25 consisting of silicon nitride as at least one of the layer of high refractive index 21 and the layer of low refractive index 22. The barrier layer 25 has a density of 2.7 g/cm³ or more and a thickness of 15 nm or more and 150 nm or less. It should be noted that the silicon nitride constituting the barrier layer 25 contains oxygen as an impurity. The barrier layer 25 has an oxidation rate of 20% or less at least during film formation in a case where a ratio between the number of oxygen atoms and the number of nitrogen atoms in the film is set to oxidation rate=number of oxygen atoms/number of nitrogen atoms.

As described above, the present inventors have found that an alkali metal such as Na contained in a high refractive index glass used as the substrate causes a change in the refractive index and a change in the structure of the fine uneven layer. As long as the film consisting of silicon nitride has a density of 2.7 g/cm³ and a thickness of 15 nm or more, it is possible to suppress an increase in reflectivity after 1000 hours of environmental testing in an environment at a temperature of 85° C. and a humidity of 85%. (refer to examples below). In addition, in this specification, all humidity values are relative humidity values.

The density of the barrier layer in the present disclosure is 2.7 g/cm³ or more. In a case where the density of the barrier layer is 2.7 g/cm³ or more, the environmental change in reflectivity can be suppressed to be small. The density of the barrier layer 25 is preferably 3.1 g/cm³ or less, and more preferably 2.9 g/cm³ or more. In a case where the density is 3.1 g/cm³ or less, peeling of the film itself due to the stress of the film can be suppressed, and thus this case is preferable. Here, the density is a value measured by an X-ray reflectivity method (XRR).

The density of the barrier layer 25 can be adjusted according to the film formation conditions. In the sputtering film formation, the film quality such as the composition and density of the barrier layer can be adjusted by changing the input power at the time of sputtering, the chamber pressure, the introduced gas species, and the like. Generally, the higher the collision energy of the sputter gas ions, the higher the density of the film to be formed. Therefore, the density of the film can be increased by increasing the input power or increasing the collision energy by reducing the distance between the substrate and the target. On the contrary, the film density can be reduced by increasing the film formation pressure, decreasing the input power, and decreasing the collision energy by increasing the distance between the substrate and the target.

In addition, the thickness of the barrier layer in the present disclosure is in a range of 15 nm or more and 150 nm or less.

In a case where the thickness of the barrier layer is 15 nm or more, the environmental change in reflectivity can be suppressed to a small level. Further, in a case where the thickness of the barrier layer is 150 nm or less, there is an advantage that the stress of the film can be reduced and the occurrence of cracking and film peeling can be suppressed. In the above range, the thickness of the barrier layer 25 is preferably 20 nm or more and 100 nm or less. The thickness is an average thickness in an acquired image obtained by acquiring a scanning electron microscope (SEM) image of a random cross section.

The barrier layer 25 may be provided as a layer of high refractive index or a layer of low refractive index. In a case where a layer having a refractive index lower than that of the barrier layer 25 is provided adjacent to the barrier layer 25, the barrier layer 25 functions as a layer of high refractive index. On the other hand, in a case where a layer having a refractive index higher than that of the barrier layer 25 is provided adjacent to the barrier layer 25, the barrier layer 25 functions as a layer of low refractive index.

In a case where the alkali metal diffused from the substrate 12 does not reach the fine uneven layer 30, a change in the refractive index and a change in the structure of the fine uneven layer 30 do not occur, and the deterioration in antireflection performance is suppressed. Accordingly, the barrier layer 25 may be provided in any place between the substrate 12 and the fine uneven layer 30, that is, in the dielectric multilayer film 20.

The barrier layer 25 can suppress not only penetration of the alkali metal but also penetration of water vapor and oxygen, and has excellent oxidation resistance. Water vapor and oxygen that cause oxidation penetrate the antireflection film from the surface and the substrate. In a case where a layer that is easily oxidized by water or oxygen is used as the layer constituting the dielectric multilayer film, the refractive index may be changed due to oxidation, and due to such a change in the refractive index, the antireflection performance as a whole, that is, a change in reflectivity may occur. Therefore, it is preferable to provide the barrier layer 25 directly below the fine uneven layer 30 or directly above the substrate 12 in order to suppress the penetration of water vapor or oxygen into the dielectric multilayer film. In some cases, the barrier layer of silicon nitride itself may be oxidized. However, in a case of using the material having the above density range, the oxidation rate after 100 hours in an environment at a temperature of 85° C. and a humidity of 85% is 20% or less, and a change in reflectivity can be suppressed to be small.

Particularly, as shown in FIG. 1, it is preferable that the barrier layer 25 is provided on the side closest to the substrate 12 in the dielectric multilayer film 20 to be adjacent to the substrate 12. Although the barrier layer 25 is provided as the layer of high refractive index 21 in FIG. 2, the barrier layer 25 may be provided adjacent to the substrate 12 as the layer of low refractive index 22. In addition, in a case where the barrier layer 25 is provided as one of the layers of high refractive index 21, as shown in FIG. 2, it is preferable that the layer of low refractive index 22 is provided adjacent to the substrate 12, and the barrier layer is provided adjacent to the layer of low refractive index 22. By providing the barrier layer 25 in the dielectric multilayer film 20 in contact with the substrate 12 or as the second layer from the substrate 12, deterioration in optical characteristics due to moisture and oxygen that penetrate the dielectric multilayer film 20 from the substrate 12 side can be suppressed.

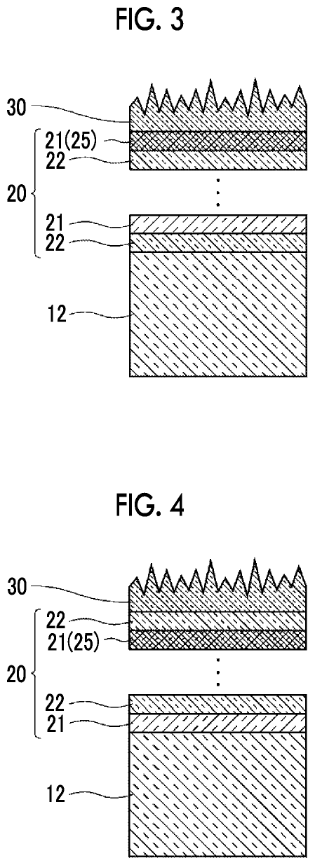

Alternatively, as shown in FIG. 3, it is preferable that the barrier layer 25 is provided on the side closest to the fine uneven layer 30 to be adjacent to the fine uneven layer 30 in the dielectric multilayer film 20. Although the barrier layer 25 is provided as the layer of high refractive index 21 in FIG. 3, the barrier layer 25 may be provided adjacent to the fine uneven layer 30 as the layer of low refractive index 22. In a case where the barrier layer 25 is provided as one of the layers of high refractive index 21, as shown in FIG. 4, it is also preferable that the layer of low refractive index 22 is provided adjacent to the fine uneven layer 30, and the barrier layer is provided adjacent to the layer of low refractive index 22. By providing the barrier layer 25 in the dielectric multilayer film 20 in contact with the fine uneven layer 30 or as the second layer from the fine uneven layer 30, deterioration in optical characteristics due to moisture and oxygen that penetrate the dielectric multilayer film 20 from the substrate 12 side can be suppressed.

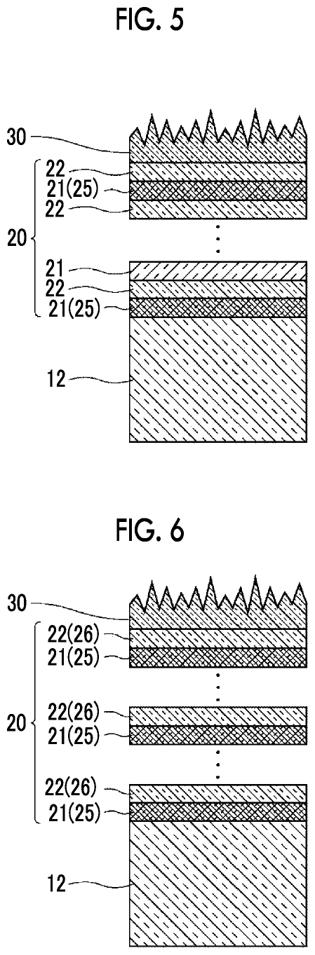

One barrier layer 25 may be provided in the dielectric multilayer film 20, but two or more barrier layers may be provided as shown in FIG. 5.

Since the barrier layer 25 consists of silicon nitride, it is particularly preferable from the viewpoint of production that the layer of high refractive index 21 is a silicon nitride film and the layer of low refractive index 22 is a silicon oxynitride film. Since the same silicon target can be used for film formation by reactive sputtering and the dielectric multilayer film can be formed simply by changing the gas species, a cost reduction effect is expected. In addition, since the same silicon-based material is used, the adhesiveness between the layers is good. In a case where a silicon nitride film is used as the layer of high refractive index 21, one of the plurality of silicon nitride films may be the barrier layer 25, and the other silicon nitride film may be a film which does not satisfy the above density and film thickness and does not have barrier properties.

However, a silicon nitride film having a low density or a small thickness is easily oxidized and may be oxidized by oxygen or moisture. Thus, it is preferable that all the silicon nitride films used as the layers of high refractive index 21 are barrier layers having a barrier function. Alternatively, among the plurality of layers of high refractive index 21, it is preferable that the layers of high refractive index arranged on the side closest to the substrate 12 and on the side closest to the fine uneven layer 30 are the barrier layers 25.

The most preferable structure is that all the layers of high refractive index 21 are the barrier layers 25 and all the layers of low refractive index 22 are silicon oxynitride films 26 as shown in FIG. 6. An antireflection film of the design modification example shown in FIG. 6 includes a dielectric multilayer film 20 formed by alternately laminating a barrier layer 25 and a silicon oxynitride film 26 while using the barrier layer 25 consisting of silicon nitride as a layer of high refractive index 21, and the silicon oxynitride film 26 as a layer of low refractive index 22, and a barrier layer 25, and a fine uneven layer 30 having an alumina hydrate as a main component on a substrate 12. Such an antireflection film has excellent durability and long-term reliability. In FIG. 6, the layers of high refractive index 21 as the barrier layer 25 are provided on the side closest to the substrate 12 and adjacent to the layer of low refractive index 22 most adjacent to the fine uneven layer 30, but the layer of low refractive index 22 may be provided on the side closest to the substrate 12. In addition, the layer of high refractive index 21 as the barrier layer 25 may be provided on the side closest to the finest uneven layer 30.

The fine uneven layer 30 is a layer whose main component is an alumina hydrate. Here, the term “main component” means that the content of alumina hydrate in the fine uneven layer 30 is 80% by mass or more. The alumina hydrate constituting the fine uneven layer 30 is boehmite (expressed as Al₂O₃.H₂O or AlOOH), which is alumina monohydrate, bayerite (expressed as Al₂O₃.3H₂O or Al(OH)₃), which is alumina trihydrate (aluminum hydroxide), and the like.

The fine uneven layer 30 is transparent and although the size (apex angle size) and the direction of convex portions are various, the fine uneven layer has an approximately sawtooth-shaped cross section. In order to exhibit antireflection performance, it is required that a distance between the convex portions of the fine uneven layer 30 is smaller than the wavelength of light of which reflection is to be prevented. The distance between the convex portions of the fine uneven layer 30 refers to a distance between the apexes of adjacent convex portions separated by a concave portion. The distance between the convex portions is preferably of the order of several tens of nm to several hundreds of nm, more preferably 200 nm or less, and even more preferably 150 nm or less. The average distance between the convex portions can be obtained by taking a surface image of the fine uneven layer with an SEM, performing image processing for binarization, and performing statistical processing.

The thickness of the fine uneven layer 30 is preferably 5 nm to 1000 nm, and more preferably 20 to 500 nm.

The fine uneven layer 30 consisting of an alumina hydrate is obtained by forming a thin film of aluminum or an aluminum alloy or a thin film of a compound containing aluminum such as alumina (hereinafter, collectively referred to as an aluminum-containing layer), and performing a hot water treatment. Here, the warm water treatment is a treatment of immersing the film in warm water of 60° C. or higher for 1 minute or longer. The aluminum-containing layer can be formed by a sputtering method, a vacuum deposition method, a sol-gel method, or the like. Particularly, it is preferable to perform a hot water treatment after forming an aluminum film by vapor deposition such as vacuum deposition, plasma sputtering, electron cyclotron sputtering, or ion plating. It is preferable to use ultrapure water for the hot water treatment. Here, the ultrapure water is pure water having an electric conductivity of 10 MΩ·cm or more.

The substrate 12 is an optical element mainly used in an optical device such as a flat plate, a concave lens, a convex lens, and a lens in which a curved surface having a positive or negative curvature and a flat surface face each other. As the material for the substrate 12, glass, plastic, or the like can be used. The present disclosure is suitable in a case of using a substrate (for example, high refractive index glass) having a refractive index of 1.6 or more for light having a wavelength of 500 nm. This is because the high refractive index glass contains a metal oxide such as TiO₂ and also contains an alkali metal such as Na as an unavoidable impurity. A transparent substrate is usually used as the substrate. However, the substrate of the antireflection film of the present disclosure is not limited to the transparent substrate, and is not particularly limited as long as the substrate is a substrate having a surface for which antireflection is desired.

By combining the fine uneven layer containing an alumina hydrate as the main component with the dielectric multilayer film as in the present embodiment, it is possible to realize an ultralow reflection film having a significantly reduced reflectivity as compared with the antireflection film consisting of only the dielectric multilayer film. Therefore, even a slight diffusion of Na has a great influence on the performance deterioration.

In the present disclosure, by providing the barrier layer that suppresses the diffusion of Na is provided between the substrate and the fine uneven layer, the diffusion of Na to the fine uneven layer side is suppressed, and a change in the refractive index and a change in the structure of the fine uneven layer are suppressed.

### EXAMPLES

Hereinafter, examples and comparative examples of the present disclosure will be described, and the configurations and effects of the present disclosure will be described in more detail.

[Relationship Between Density of Silicon Nitride Film and Na Diffusion Length]

A 30 nm silicon nitride film was formed on a FDS-90SG (manufactured by HOYA Corporation) substrate by sputtering under five different film formation conditions, and the density and diffusion length of each film were measured. The respective films are respectively SiN-A, SiN-B, SiN-C, SiN-D, and SiN-E. The density was measured by XRR before environmental testing for diffusion length measurement. In addition, each film was subjected to an environmental testing in an environment at a temperature of 85° C. and a humidity of 85% for 100 hours, and then Na was measured in the depth direction from the film surface by TOF-SIMS (time-of-flight secondary ion mass spectrometry). The distance from the surface of the substrate to the depth position where Na was detected was set to a diffusion length. The density and diffusion length of each film are shown in Table 1.

TABLE 1

| Silicon nitride film | | Na diffusion length after |
|---|---|---|
| sample | Density | environmental testing |
| SiN-A | 2.5 g/cm3 | 30 nm |
| SiN-B | 2.7 g/cm3 | 10 nm |
| SiN-C | 2.9 g/cm3 | 5 nm |
| SiN-D | 3.1 g/cm3 | 5 nm |
| SiN-E | 3.3 g/cm3 | 5 nm |

SiN-A does not satisfy the requirement that the density is 2.7 g/cm³ or more, and is not a barrier layer. As shown in Table 1, it is found that all of SiN-B, SiN-C, SiN-D, and SiN-E having a density of 2.7 g/cm³ or more have a Na diffusion length of 10 nm or less after the environmental testing, and have an effect of suppressing the diffusion of Na. In addition, as long as the density was 2.9 g/cm³ or more, the Na diffusion length could be suppressed to 5 nm or less.

Next, the antireflection film of each of Comparative Examples and Examples was formed on the substrate, and the reflectivity before and after the environmental testing was measured to evaluate the durability.

In Tables 2, 3 and 4 described below, the configurations of the dielectric multilayer films of the antireflection films of Comparative Examples 1 to 3 and Examples 1 to 30 (the upper part indicates the material, and the lower part indicates the thickness) and evaluation results are collectively shown. Each of the dielectric multilayer films had an eight-layer structure or a nine-layer structure in which a layer of high refractive index and a layer of low refractive index were alternately laminated. In the tables, for convenience, the dielectric multilayer films are numbered 1, 2, . . . as the first layer, the second layer, . . . from the substrate side.

[Preparation Method]

Among the layers constituting the dielectric multilayer film, the silicon nitride (SiN) film, the silicon oxynitride (SiON) film, the niobium oxide (Nb₂O₅) film, and the alumina (Al₂O₃) film that is a precursor of the fine uneven layer were formed by reactive sputtering, respectively. Among the layers constituting the dielectric multilayer film, the magnesium fluoride (MgF₂) film was formed by vacuum vapor deposition.

The SiN film was formed under the film formation conditions of any of SiN-A to SiN-E, and in Tables 2 to 4, the film formation conditions are expressed as SiN-A to SiN-E in correspondence with the adopted film formation conditions.

On the FDS-90SG (manufactured by HOYA Corporation) substrate, each layer having the composition and thickness shown in Tables 2 to 4 was sequentially formed to form a dielectric multilayer film.

Then, the film was immersed in boiling water at 100° C. for 1 minute for a hot water treatment to hydrate the alumina film to form a fine uneven layer having an alumina hydrate as the main component.

The antireflection film of each of Comparative Examples and Examples was prepared by the above procedure.

With respect to the antireflection films of Examples and Comparative Examples, the average reflectivity in a wavelength range of 400 nm to 700 nm was measured in an environment at a temperature of 85° C. and a humidity of 85% before and after the environmental testing for 1000 hours. Tables 2 to 4 show the reflectivities before and after the environmental testing, differences thereof, and the evaluation results. The evaluation based on the difference A is also shown. The evaluation was performed according to the following standards.

A: The difference in reflectivity is 0.05 or less.

B: The difference in reflectivity is more than 0.05 and 0.1 or less.

C: The difference in reflectivity is more than 0.1 and 0.3 or less.

D: The difference in reflectivity is more than 0.3 and 0.5 or less.

E: The difference in reflectivity is more than 0.5.

TABLE 2

| | | Dielectric multilayer film | | | | | | | |
|---|---|---|---|---|---|---|---|---|---|
| | Substrate | 1 | 2 | 3 | 4 | 5 | 6 | 7 | 8 |
| Comparative | FDS-90SG | Nb2O5 | SiON | Nb2O5 | SiON | Nb2O5 | SiON | Nb2O5 | SiON |
| Example 1 | | 7.2 nm | 29.1 nm | 26.1 nm | 23.7 nm | 74.9 nm | 4.9 nm | 37.4 nm | 87.8 nm |
| Comparative | FDS-90SG | Nb2O5 | SiON | Nb2O5 | SiON | Nb2O5 | SiON | Nb2O5 | SiON |
| Example 2 | | 16.8 nm | 25.9 nm | 40.0 nm | 23.3 nm | 39.0 nm | 38.6 nm | 18.0 nm | 122.6 nm |
| Comparative | FDS-90SG | SiN-A | SiON | Nb2O5 | SiON | Nb2O5 | SiON | Nb2O5 | SiON |
| Example 3 | | 21.5 nm | 22.9 nm | 25.5 nm | 34.6 nm | 28.0 nm | 46.7 nm | 15.4 nm | 124.7 nm |
| Example 1 | FDS-90SG | SiN-B | SiON | Nb2O5 | SiON | Nb2O5 | SiON | Nb2O5 | SiON |
| | | 21.5 nm | 22.9 nm | 25.5 nm | 34.6 nm | 28.0 nm | 46.7 nm | 15.4 nm | 124.7 nm |
| Example 2 | FDS-90SG | SiN-C | SiON | Nb2O5 | SiON | Nb2O5 | SiON | Nb2O5 | SiON |
| | | 21.5 nm | 22.9 nm | 25.5 nm | 34.6 nm | 28.0 nm | 46.7 nm | 15.4 nm | 124.7 nm |
| Example 3 | FDS-90SG | SiN-D | SiON | Nb2O5 | SiON | Nb2O5 | SiON | Nb2O5 | SiON |
| | | 21.5 nm | 22.9 nm | 25.5 nm | 34.6 nm | 28.0 nm | 46.7 nm | 15.4 nm | 124.7 nm |
| Example 4 | FDS-90SG | SiN-E | SiON | Nb2O5 | SiON | Nb2O5 | SiON | Nb2O5 | SiON |
| | | 21.5 nm | 22.9 nm | 25.5 nm | 34.6 nm | 28.0 nm | 46.7 nm | 15.4 nm | 124.7 nm |
| Example 5 | FDS-90SG | Nb2O5 | SiON | Nb2O5 | SiON | Nb2O5 | SiON | SiN-C | SiON |
| | | 12.7 nm | 30.9 nm | 25.5 nm | 35.0 nm | 28.0 nm | 42.3 nm | 28.0 nm | 126.8 nm |
| Example 6 | FDS-90SG | SiN-B | SiON | Nb2O5 | SiON | Nb2O5 | SiON | Nb2O5 | SiON |
| | | 15 nm | 22.9 nm | 25.5 nm | 34.6 nm | 28.0 nm | 46.7 nm | 15.4 nm | 124.7 nm |
| Example 7 | FDS-90SG | SiN-B | SiON | Nb2O5 | SiON | Nb2O5 | SiON | Nb2O5 | SiON |
| | | 20 nm | 22.9 nm | 25.5 nm | 34.6 nm | 28.0 nm | 46.7 nm | 15.4 nm | 124.7 nm |
| Example 8 | FDS-90SG | SiN-B | SiON | Nb2O5 | SiON | Nb2O5 | SiON | Nb2O5 | SiON |
| | | 100 nm | 22.9 nm | 25.5 nm | 34.6 nm | 28.0 nm | 46.7 nm | 15.4 nm | 124.7 nm |
| Example 9 | FDS-90SG | SiN-B | SiON | Nb2O5 | SiON | Nb2O5 | SiON | Nb2O5 | SiON |
| | | 150 nm | 22.9 nm | 25.5 nm | 34.6 nm | 28.0 nm | 46.7 nm | 15.4 nm | 124.7 nm |

| | Uneven | Reflectivity [%] | | | |
|---|---|---|---|---|---|
| | structure | Before | After | | |
| | layer | environmental | environmental | | Evaluation |
| | precursor | testing | testing | Δ | result |
| Comparative | | 0.89 | 0.93 | 0.04 | A |
| Example 1 | | | | | |
| Comparative | Al2O3 | 0.04 | 0.96 | 0.92 | E |
| Example 2 | 50.0 nm | | | | |
| Comparative | Al2O3 | 0.13 | 1.03 | 0.90 | E |
| Example 3 | 50.0 nm | | | | |
| Example 1 | Al2O3 | 0.06 | 0.31 | 0.25 | C |
| | 50.0 nm | | | | |
| Example 2 | Al2O3 | 0.04 | 0.07 | 0.03 | A |
| | 50.0 nm | | | | |
| Example 3 | Al2O3 | 0.05 | 0.09 | 0.04 | A |
| | 50.0 nm | | | | |
| Example 4 | A12O3 | 0.09 | 0.16 | 0.07 | B |
| | 50.0 nm | | | | |
| Example 5 | Al2O3 | 0.03 | 0.06 | 0.03 | A |
| | 50.0 nm | | | | |
| Example 6 | Al2O3 | 0.11 | 0.56 | 0.45 | D |
| | 50.0 nm | | | | |
| Example 7 | Al2O3 | 0.07 | 0.32 | 0.25 | C |
| | 50.0 nm | | | | |
| Example 8 | Al2O3 | 0.83 | 0.90 | 0.07 | B |
| | 50.0 nm | | | | |
| Example 9 | Al2O3 | 0.45 | 0.50 | 0.05 | A |
| | 50.0 nm | | | | |

### Comparative Examples 1 to 3

Comparative Examples 1 to 3 are antireflection films not comprising a barrier layer. Comparative Example 1 is an antireflection film consisting of only a fine uneven layer and a dielectric multilayer film that does not include a silicon nitride film. Comparative Example 2 is an antireflection film having a fine uneven layer and not having a silicon nitride film in the dielectric multilayer film. In addition, Comparative Example 3 is an antireflection film having a fine uneven layer and a SiN-A film in the dielectric multilayer film.

It can be found that from Comparative Examples 1 and 2 that a very small initial reflectivity can be obtained by providing the fine uneven layer. On the other hand, a change in reflectivity before and after the environmental testing was only 0.04% in Comparative Example 1, but a change in reflectivity before and after the environmental testing was 0.92% in Comparative Example 2. The results show that this is due to a change in the refractive index and/or the structure of the fine uneven layer.

In Comparative Example 3, it is found that although the silicon nitride film SiN-A is provided in the dielectric multilayer film, the reflectivity is greatly changed and does not function as a barrier layer.

### Examples 1 to 5

Examples 1 to 4 are antireflection films provided with one of SiN-B to SiN-E as a barrier layer and as the first layer in the dielectric multilayer film, that is, at a position adjacent to the substrate. The barrier layers in Examples 1 to 4 had a common thickness of 21.5 nm.

In Example 5, an antireflection film in which the barrier layer consisting of SiN-C was used as the seventh layer of the dielectric multilayer film, that is, arranged at a position adjacent to the layer of low refractive index adjacent to the fine uneven layer was formed.

In each of Examples 1 to 5, a change in reflectivity was small as compared with Comparative Example 2 and Comparative Example 3, and the results showing that the barrier function of the barrier layer was effective were obtained. Particularly, in Examples 2 to 5 comprising SiN-C, SiN-D, and SiN-E having a density of 2.9 g/cm³ or more, a change in reflectivity was 0.1% or less, and the effect was very high. In Examples 2 and 5, although the position of the barrier layer is different, SiN-C is provided as the barrier layer. It is found that in Examples 2 and 5, a change in reflectivity is very small, and similar effects can be obtained regardless of the position of the barrier layer.

### Examples 6 to 9

Examples 6 to 9 are antireflection films each comprising a barrier layer consisting of SiN-B at a position adjacent to the substrate in the dielectric multilayer film, and the thicknesses of the barrier layers were set to 15 nm, 20 nm, 100 nm and 150 nm respectively.

According to the results of Examples 6 to 9, for the barrier layer consisting of SiN-B, as the film thickness becomes larger, the effect of suppressing a change in reflectivity becomes higher.

TABLE 3

| | | Dielectric multilayer film | | | | | |
|---|---|---|---|---|---|---|---|
| | Substrate | 1 | 2 | 3 | 4 | 5 | 6 |
| Example 10 | FDS-90SG | SiN-C | SiON | Nb2O5 | SiON | Nb2O5 | SiON |
| | | 15 nm | 22.9 nm | 25.5 nm | 34.6 nm | 28.0 nm | 46.7 nm |
| Example 11 | FDS-90SG | SiN-C | SiON | Nb2O5 | SiON | Nb2O5 | SiON |
| | | 20 nm | 22.9 nm | 25.5 nm | 34.6 nm | 28.0 nm | 46.7 nm |
| Example 12 | FDS-90SG | SiN-C | SiON | Nb2O5 | SiON | Nb2O5 | SiON |
| | | 100 nm | 22.9 nm | 25.5 nm | 34.6 nm | 28.0 nm | 46.7 nm |
| Example 13 | FDS-90SG | SiN-C | SiON | Nb2O5 | SiON | Nb2O5 | SiON |
| | | 150 nm | 22.9 nm | 25.5 nm | 34.6 nm | 28.0 nm | 46.7 nm |
| Example 14 | FDS-90SG | SiN-D | SiON | Nb2O5 | SiON | Nb2O5 | SiON |
| | | 15 nm | 22.9 nm | 25.5 nm | 34.6 nm | 28.0 nm | 46.7 nm |
| Example 15 | FDS-90SG | SiN-D | SiON | Nb2O5 | SiON | Nb2O5 | SiON |
| | | 20 nm | 22.9 nm | 25.5 nm | 34.6 nm | 28.0 nm | 46.7 nm |
| Example 16 | FDS-90SG | SiN-D | SiON | Nb2O5 | SiON | Nb2O5 | SiON |
| | | 100 nm | 22.9 nm | 25.5 nm | 34.6 nm | 28.0 nm | 46.7 nm |
| Example 17 | FDS-90SG | SiN-D | SiON | Nb2O5 | SiON | Nb2O5 | SiON |
| | | 150 nm | 22.9 nm | 25.5 nm | 34.6 nm | 28.0 nm | 46.7 nm |
| Example 18 | FDS-90SG | SiN-E | SiON | Nb2O5 | SiON | Nb2O5 | SiON |
| | | 15 nm | 22.9 nm | 25.5 nm | 34.6 nm | 28.0 nm | 46.7 nm |
| Example 19 | FDS-90SG | SiN-E | SiON | Nb2O5 | SiON | Nb2O5 | SiON |
| | | 20 nm | 22.9 nm | 25.5 nm | 34.6 nm | 28.0 nm | 46.7 nm |
| Example 20 | FDS-90SG | SiN-E | SiON | Nb2O5 | SiON | Nb2O5 | SiON |
| | | 100 nm | 22.9 nm | 25.5 nm | 34.6 nm | 28.0 nm | 46.7 nm |
| Example 21 | FDS-90SG | SiN-E | SiON | Nb2O5 | SiON | Nb2O5 | SiON |
| | | 150 nm | 22.9 nm | 25.5 nm | 34.6 nm | 28.0 nm | 46.7 nm |

| | | | | Reflectivity [%] | | | |
|---|---|---|---|---|---|---|---|
| | | | Uneven | Before | After | | |
| | | | structure | environ- | environ- | | Evalu- |
| | Dielectric multilayer film | | layer | mental | mental | | ation |
| | 7 | 8 | precursor | testing | testing | Δ | result |
| Example 10 | Nb2O5 | SiON | Al2O3 | 0.06 | 0.13 | 0.07 | B |
| | 15.4 nm | 124.7 nm | 50.0 nm | | | | |
| Example 11 | Nb2O5 | SiON | Al2O3 | 0.04 | 0.07 | 0.03 | A |
| | 15.4 nm | 124.7 nm | 50.0 nm | | | | |
| Example 12 | Nb2O5 | SiON | Al2O3 | 1.18 | 1.20 | 0.02 | A |
| | 15.4 nm | 124.7 nm | 50.0 nm | | | | |
| Example 13 | Nb2O5 | SiON | Al2O3 | 0.56 | 0.59 | 0.03 | A |
| | 15.4 nm | 124.7 nm | 50.0 nm | | | | |
| Example 14 | Nb2O5 | SiON | Al2O3 | 0.04 | 0.12 | 0.08 | B |
| | 15.4 nm | 124.7 nm | 50.0 nm | | | | |
| Example 15 | Nb2O5 | SiON | Al2O3 | 0.04 | 0.08 | 0.04 | A |
| | 15.4 nm | 124.7 nm | 50.0 nm | | | | |
| Example 16 | Nb2O5 | SiON | Al2O3 | 1.58 | 1.63 | 0.05 | A |
| | 15.4 nm | 124.7 nm | 50.0 nm | | | | |
| Example 17 | Nb2O5 | SiON | Al2O3 | 0.72 | 0.79 | 0.07 | B |
| | 15.4 nm | 124.7 nm | 50.0 nm | | | | |
| Example 18 | Nb2O5 | SiON | Al2O3 | 0.04 | 0.12 | 0.08 | B |
| | 15.4 nm | 124.7 nm | 50.0 nm | | | | |
| Example 19 | Nb2O5 | SiON | Al2O3 | 0.09 | 0.16 | 0.07 | B |
| | 15.4 nm | 124.7 nm | 50.0 nm | | | | |
| Example 20 | Nb2O5 | SiON | Al2O3 | 2.00 | 2.14 | 0.14 | C |
| | 15.4 nm | 124.7 nm | 50.0 nm | | | | |
| Example 21 | Nb2O5 | SiON | Al2O3 | 0.93 | 1.21 | 0.28 | C |
| | 15.4 nm | 124.7 nm | 50.0 nm | | | | |

### Examples 10 to 13

Examples 10 to 13 are antireflection films each comprising a barrier layer consisting of SiN-C at a position adjacent to the substrate in the dielectric multilayer film, and the thicknesses of the barrier layers were set to 15 nm, 20 nm, 100 nm and 150 nm, respectively.

According to the results of Examples 10 to 13, for the barrier layer consisting of SiN-C, a change in reflectivity was less than 0.1% regardless of the thickness, and very high durability was obtained.

### Examples 14 to 17

Examples 14 to 17 are antireflection films each comprising a barrier layer consisting of SiN-D at a position adjacent to the substrate in the dielectric multilayer film, and the thicknesses of the barrier layers were set to 15 nm, 20 nm, 100 nm and 150 nm, respectively.

According to the results of Examples 14 to 17, the same tendency as in the case of SiN-C was obtained for the barrier layer consisting of SiN-D. That is, a change in reflectivity was less than 0.1% regardless of the thickness, and very high durability was obtained.

### Examples 18 to 21

Examples 18 to 21 are antireflection films each having a barrier layer consisting of SiN-E at a position adjacent to the substrate in the dielectric multilayer film, and the thicknesses of the barrier layers were set to 15 nm, 20 nm, 100 nm and 150 nm, respectively.

According to the results of Examples 18 to 21, the barrier layer consisting of SiN-E had a thickness of 15 nm and 20 nm, a change in reflectivity was less than 0.1%, and high durability was obtained. Even in a case where the thicknesses of the barrier layers were 100 nm and 150 nm, a change in reflectivity was 0.3% or less. It is presumed that this is because in a case where the density of SiN-E is high and the film thickness is large, the stress of the film is strong and cracking occurs to deteriorate the barrier performance.

TABLE 4

| | | Dielectric multilayer film | | | | | | |
|---|---|---|---|---|---|---|---|---|
| | Substrate | 1 | 2 | 3 | 4 | 5 | 6 | 7 |
| Example 22 | FDS-90SG | SiN-C | SiON | Nb2O5 | SiON | SiN-A | SiON | Nb2O5 |
| | | 21.5 nm | 21.1 nm | 20.8 nm | 16.0 nm | 87.2 nm | 34.0 nm | 13.0 nm |
| Example 23 | FDS-90SG | SiN-C | SiON | Nb2O5 | SiON | SiN-A | SiON | SiN-C |
| | | 21.5 nm | 21.9 nm | 20.9 nm | 16.8 nm | 87.2 nm | 30.2 nm | 24.1 nm |
| Example 24 | FDS-90SG | SiN-C | SiON | Nb2O5 | SiON | Nb2O5 | SiON | SiN-B |
| | | 30.0 nm | 19.9 nm | 31.3 nm | 26.3 nm | 34.3 nm | 31.9 nm | 20 nm |
| Example 25 | FDS-90SG | SiN-C | SiON | Nb2O5 | SiON | Nb2O5 | SiON | SiN-B |
| | | 30.0 nm | 19.9 nm | 31.3 nm | 26.3 nm | 34.3 nm | 31.9 nm | 33.7 nm |
| Example 26 | FDS-90SG | SiN-C | SiON | Nb2O5 | SiON | Nb2O5 | SiON | SiN-C |
| | | 30.0 nm | 19.9 nm | 31.3 nm | 26.3 nm | 34.3 nm | 31.9 nm | 33.7 nm |
| Example 27 | FDS-90SG | SiN-C | SiON | SiN-C | SiON | SiN-C | SiON | SiN-C |
| | | 21.5 nm | 14.9 nm | 58.5 nm | 10.0 nm | 66.9 nm | 27.8 nm | 27.2 nm |
| Example 28 | FDS-90SG | SiN-C | MgF2 | SiN-C | MgF2 | SiN-C | MgF2 | SiN-C |
| | | 25.4 nm | 11.4 nm | 74.1 nm | 10.6 nm | 52.0 nm | 39.0 nm | 20.0 nm |
| Example 29 | FDS-90SG | SiON | SiN-C | SiON | SiN-C | SiON | SiN-C | SiON |
| | | 21.2 nm | 32.6 nm | 40.2 nm | 42.6 nm | 31.5 nm | 52.3 nm | 36.9 nm |
| Example 30 | FDS-90SG | SiN-C | SiON | SiN-C | SiON | SiN-C | SiON | SiN-C |
| | | 15.0 nm | 18.6 nm | 44.0 nm | 15.2 nm | 84.5 nm | 12.4 nm | 44.5 nm |

| | | | | Reflectivity [%] | | | |
|---|---|---|---|---|---|---|---|
| | | | Uneven | Before | After | | |
| | | | structure | environ- | environ- | | |
| | Dielectric multilayer film | | layer | mental | mental | | Evaluation |
| | 8 | 9 | precursor | testing | testing | Δ | result |
| Example 22 | SiON | — | Al2O3 | 0.04 | 0.45 | 0.41 | D |
| | 120.8 nm | | 50.0 nm | | | | |
| Example 23 | SiON | — | Al2O3 | 0.04 | 0.07 | 0.03 | A |
| | 121.2 nm | | 50.0 nm | | | | |
| Example 24 | SiON | | Al2O3 | 1.04 | 1.24 | 0.20 | C |
| | 120.2 nm | | 50.0 nm | | | | |
| Example 25 | SiON | — | Al2O3 | 0.07 | 0.15 | 0.08 | B |
| | 120.2 nm | | 50.0 nm | | | | |
| Example 26 | SiON | — | Al2O3 | 0.06 | 0.08 | 0.02 | A |
| | 120.2 nm | | 50.0 nm | | | | |
| Example 27 | SiON | — | Al2O3 | 0.04 | 0.05 | 0.01 | A |
| | 118.0 nm | | 50.0 nm | | | | |
| Example 28 | MgF2 | | Al2O3 | 0.08 | 0.15 | 0.07 | B |
| | 154.2 nm | | 50.0 nm | | | | |
| Example 29 | SiN-C | SiON | Al2O3 | 0.05 | 0.08 | 0.03 | A |
| | 27.7 nm | 123.7 nm | 50.0 nm | | | | |
| Example 30 | SiON | SiN-C | Al2O3 | 0.07 | 0.09 | 0.02 | A |
| | 54.1 nm | 15.0 nm | 50.0 nm | | | | |

### Examples 22 and 23

In Examples 22 and 23, antireflection films in which a barrier layer consisting of SiN-C was provided at a position adjacent to the substrate in the dielectric multilayer film, and a silicon nitride film, which was not a barrier layer, was provided as the fifth layer in the dielectric multilayer film were obtained. In Example 23, a barrier layer consisting of SiN-C was further provided as the seventh layer.

### Examples 24 and 25

In Examples 24 and 25, antireflection films in which a barrier layer consisting of SiN-C was provided at a position adjacent to the substrate in the dielectric multilayer film, and as the seventh layer in the dielectric multilayer film, that is, at a position adjacent to the layer of low refractive index adjacent to the fine uneven layer, a barrier layer consisting of SiN-B was provided were obtained. The SiN-B in Examples 24 and 25 have different thicknesses.

### Example 26

Example 26 is an antireflection film in which the barrier layer of the seventh layer in Example 25 is changed to SiN-C.

### Example 27

Example 27 is an antireflection film in which all the layers of high refractive index in the dielectric multilayer film are barrier layers consisting of SiN-C and all the layers of low refractive index are SiON films.

### Example 28

Example 28 is an antireflection film in which all the layers of low refractive index in Example 27 are changed to MgF₂.

### Examples 29 and 30

Examples 29 and 30 are antireflection films in which all the layers of high refractive index in the dielectric multilayer film are barrier layers consisting of SiN-C, all the layers of low refractive index are SiON films, and the dielectric multilayer film had a nine-layer structure. In Example 29, the side closest to the substrate in the dielectric multilayer film is the layer of low refractive index, and in Example 30, the side closest to the substrate in the dielectric multilayer film is the layer of high refractive index.

In Examples 23 and 26 to 30 in which the barrier layer consisting of SiN-C was provided on the side closest to the substrate and at a position where the layer of low refractive index was sandwiched from the fine uneven layer in the dielectric layer, a change in reflectivity was 0.1% or less, and very high durability was obtained.

[Oxidation Rate of Silicon Nitride Film]

The oxidation rates of the silicon nitride films of SiN-A of the fifth layer of Examples 22 and 23, SiN-B of the seventh layer of Examples 24 and 25, and SiN-C of the seventh layer of Example 26 were measured.

Each film was subjected to environmental testing for 100 hours in a greenhouse environment at a temperature of 85° C. and a humidity of 85%. Before and after the environmental testing, elemental analysis in the depth direction was performed by X-ray photoelectron spectroscopy (XPS) to measure the oxidation rate. The ratio of the number of oxygen atoms and the number of nitrogen atoms in each silicon nitride film was obtained as oxidation rate=number of oxygen atoms/number of nitrogen atoms. The number of oxygen atoms and the number of nitrogen atoms are the total number of atoms in the film obtained by integrating the measurement results in the depth direction.

TABLE 5

Oxidation rate

| | | Before | After |
|---|---|---|---|
| | | environmental | environmental |
| Silicon nitride film sample | | testing | testing |
| Example 22 | SiN-A | 20% | 50% |
| Example 23 | SiN-A | 20% | 20% |
| Example 24 | SiN-B | 10% | 30% |
| Example 25 | SiN-B | 10% | 20% |
| Example 26 | SiN-C | 10% | 15% |

In Example 23, it is considered that since water and oxygen are prevented from penetrating SiN-A of the fifth layer by SiN-C of the first layer and SiN-C of the seventh layer, a change in the oxidation rate before and after the environmental testing is suppressed. On the other hand, in Example 22, it is considered that since the barrier layer is not provided on the fine uneven layer side of SiN-A, it was not possible to prevent the penetration of water and oxygen from the side of the fine uneven layer, and oxidation proceeded. Then, it is presumed that a change in reflectivity in Table 4 in Example 22 is larger than that in Example 23 due to the influence of the oxidation of SiN-A.

It was found that the thickness of SiN-B is different in Examples 24 and 25, and as the thickness becomes larger, an increase in the oxidation rate can be further suppressed. Further, from the results of Examples 25 and 26, it can be found that the oxidation rate of SiN-C, which has a high film density, can be further suppressed than the oxidation rate of SiN-B.

In addition, it is found that in Examples 25 and 26 in which the oxidation rate of the silicon nitride film of the seventh layer is 20% or less, after the environmental testing for 100 hours, a change in reflectivity shown in Table 4 is 0.1% or less, and very high durability is obtained. Further, in the antireflection film of Example 26 having an oxidation rate of 15% or less, a change in reflectivity was 0.02%, and particularly high durability was obtained.

[Evaluation of Adhesiveness]

With respect to Examples 27 and 28, samples with up to the dielectric multilayer film provided were separately formed, after the environmental testing, a pressure sensitive adhesive tape was attached to the surface, and a peeling adhesiveness test was performed.

As a result of the adhesiveness test, tape peeling was observed in the sample corresponding to Example 28, and tape peeling was not observed in the sample corresponding to Example 27. This indicates that the antireflection film of Example 27 has higher adhesiveness between layers than the antireflection film of Example 28. In the antireflection film of Example 27, it is presumed that since the layer of high refractive index was formed of a SiN film, the layer of low refractive index was formed of a SiON film, and all the layers constituting the dielectric multilayer film were formed of a silicon-based material, the adhesiveness of each layer of the dielectric multilayer film is good.

The entire disclosure of Japanese Patent Application No. 2018-063900 filed on Mar. 29, 2018 is incorporated herein by reference.

All documents, patent applications, and technical standards described herein are incorporated herein by reference to the same extent as if each individual document, patent application and technical standard were specifically and individually indicated to be incorporated by reference.

What is claimed is:

1. An antireflection film provided on one surface of a substrate, the film comprising:
a dielectric multilayer film arranged on the substrate side; and
a fine uneven layer having an alumina hydrate as a main component and provided to be laminated on the dielectric multilayer film,
wherein the dielectric multilayer film includes alternating layers of layers of high refractive index having a relatively high refractive index and layers of low refractive index having a relatively low refractive index,
the dielectric multilayer film includes a barrier layer containing silicon nitride as one of the layer of high refractive index and the layer of low refractive index, and
the barrier layer has a density of 2.7 g/cm³ or more and a thickness of 15 nm or more and 150 nm or less.

2. The antireflection film according to claim 1,
wherein the barrier layer has a density of 3.1 g/cm³ or less.

3. The antireflection film according to claim 1,
wherein the barrier layer has a thickness of 20 nm or more.

4. The antireflection film according to claim 1,
wherein the barrier layer has a thickness of 100 nm or less.

5. The antireflection film according to claim 1,
wherein the barrier layer is provided adjacent to the substrate.

6. The antireflection film according to claim 1,
wherein one of the layers of low refractive index is arranged adjacent to the substrate, and the barrier layer is provided adjacent to the layer of low refractive index arranged adjacent to the substrate.

7. The antireflection film according to claim 1,
wherein the barrier layer is provided adjacent to the fine uneven layer.

8. The antireflection film according to claim 1,
wherein one of the layers of low refractive index is arranged adjacent to the fine uneven layer, and the barrier layer is provided adjacent to the layer of low refractive index arranged adjacent to the fine uneven layer.

9. The antireflection film according to claim 1,
wherein the dielectric multilayer film includes two or more of the barrier layers.

10. The antireflection film according to claim 1,
wherein the barrier layer is provided as one of the layers of high refractive index, and
the layer of low refractive index consists of silicon oxynitride.

11. An optical member comprising:
a substrate; and
the antireflection film according to claim 1 provided on one surface of the substrate.

12. The optical member according to claim 11,
wherein the substrate has a refractive index of 1.6 or more at a wavelength of 500 nm.
